(19) United States
(12) Patent Application Publication
(10) Pub. No.: US 2009/0285587 A1
(43) Pub. Date: Nov. 19, 2009

(54) IMAGE FORMING APPARATUS

(76) Inventor: Keisuke MORITA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/463,905

(22) Filed: May 11, 2009

(30) Foreign Application Priority Data
May 15, 2008 (JP) JP2008-127996

(51) Int. Cl. G03G 15/00

(52) U.S. Cl. 399/23

(57) ABSTRACT

An image forming apparatus including a printer section to form an image on a paper sheet; a plurality of paper feed trays; and a controller which controls the image forming apparatus to execute a job, wherein, the controller sets a paper size, a paper type, and a paper feed tray to be used for each page of the job, and wherein in cases where a first paper feed tray is refilled with the paper sheet, after the first paper feed tray runs out of the paper sheet in the course of executing a first job and is switched to a second paper feed tray by an automatic tray switching function, the controller continues to feed the paper sheet by using the second paper feed tray, even in cases where the first paper feed tray has been set as a paper feed tray for the each page of the first job.

### CROSS REFERENCE TO RELATED APPLICATION

The present application is based on Japanese Patent Application No. 2008-127996 filed with Japanese Patent Office on May 15, 2008, the entire content of which is hereby incorporated by reference.

### BACKGROUND OF THE INVENTION

1. Field of Technology

The present invention relates to an image forming apparatus, such as a copying machine, a printer, a facsimile and a multi function peripheral, which perform image formation based on image data.

2. Description of Prior Art

Conventionally, in an image forming apparatus, such as a copying machine, there are an automatic paper selection (henceforth, referred to as APS) technology, which automatically selects a tray that matches with the paper size or the paper type set up in a job (for example, refer to Unexamined Japanese Patent Application Publication No. H11-119598), and an automatic tray switching (henceforth, referred to as ATS) technology, which automatically switches to another tray that matches with the paper size or the paper type set in a job and continues to feed paper in case when the paper in the paper feed tray that was performing paper feed before ATS was executed is out (refer to Examined Japanese Patent Application Publication No. S2-43181 for matching the paper size, and refer to Unexamined Japanese Patent Application Publication No. H07-234610 for matching the paper type). In the production printing market, since various types of papers are used, it is very important as an operational condition of APS/ATS to be able to determine a tray by matching the tray not only with the paper size, but also with the paper type. In the image forming apparatus, which has the above-mentioned APS function and ATS function, a paper feed tray is selected in accordance with a tray priority order that the image forming apparatus holds or with a tray priority order that is set up by a user (for example, Unexamined Japanese Patent Application Publication No. H03-264435 and Unexamined Japanese Patent Application Publication No. H08-188280).

However, in case when the APS function and the ATS function are executed with a tray priority order as mentioned above, a specific paper feed tray will concentrically be used. Therefore, tray expendable supplies, such as a paper feed roller and a cassette of the paper feed tray, will deteriorate quickly. In order to solve this problem, an APS technology in which the frequency of use of trays becomes equivalent is proposed in Unexamined Japanese Patent Application Publication No. 2006-58645. However, the ATS is not taken in consideration. Particularly in the production printing market, in case when specifying a paper feed tray to be used with a paper size and a paper type for every page, it quickly returns to the set paper feed tray when paper is refilled to the paper feed tray that was performing the paper feed before ATS was executed even when the ATS function is used, and the paper feed tray that was performing the paper feed before ATS was executed will preferentially be selected when the ATS function is executed again. Therefore, the specific paper feed tray will concentrically be used even more.

In a JOB in which ordered paper (or papers put in order), such as a tab paper and previously printed paper, are used, the papers are set in order in each tray. Therefore, in case when a paper sheet is refilled into the paper feed tray that was performing the paper feed before the ATS function is executed and returns to the paper feed tray after the ATS function operates, there is a problem that outputting the ordered paper in order cannot be guaranteed while continuing the print operation.

The present invention was made from the above-mentioned background. An object of the present invention is to provide an image forming apparatus that prevents the usage to concentrate on a specific paper feed tray and is capable of executing a job in a state in which, such as a tab paper or previously printed paper, are set in a plurality of trays.

### SUMMARY

In order to overcome at least one of the above mentioned problems, an image forming apparatus reflecting one aspect of the present invention includes:

a printer section to form an image on a paper sheet;

a plurality of paper feed trays to feed the paper sheet; and

a controller which controls the image forming apparatus to execute a job, and the controller having a function of executing an automatic tray switching where in cases where a paper feed tray runs out of a paper sheet while performing the paper feeding for executing the job, the controller continues the paper feeding by automatically switching to another paper feed tray containing a paper sheet that matches paper conditions for the job,

wherein, the controller is capable of setting a paper size, a paper type, and a paper feed tray to be used for each page of the job, and

wherein in cases where the paper sheet is refilled into a first paper feed tray, after the first paper feed tray performing paper feeding runs out of the paper sheet in the course of executing a first job and the first paper feed tray is switched to a second paper feed tray by the automatic tray switching function, the controller continues to feed the paper sheet by using the second paper feed tray without using the first paper feed tray which is refilled with the paper sheet, even in cases where the first paper feed tray has been set as a paper feed tray for the each page of the first job.

### BRIEF DESCRIPTION OF THE DRAWINGS

These and other objects, advantages and features of the invention will become apparent from the following description thereof taken in conjunction with the accompanying drawings in which:

FIG. 1 illustrates an entire mechanical configuration of an image forming apparatus of an embodiment of the present invention;

FIG. 2 illustrates a control block of the image forming apparatus of an embodiment of the present invention;

FIG. 3 illustrates an example of a screen display for setting a paper size, a paper type and a tray number of the image forming apparatus of an embodiment of the present invention;

FIG. 4 illustrates a flow chart of an example of a control procedure of the image forming apparatus of an embodiment of the present invention; and

FIG. 5 illustrates a flow chart of another example of a control procedure of the image forming apparatus of an embodiment of the present invention.

### DETAILED DESCRIPTION OF THE PREFERRED EMBODIMENT

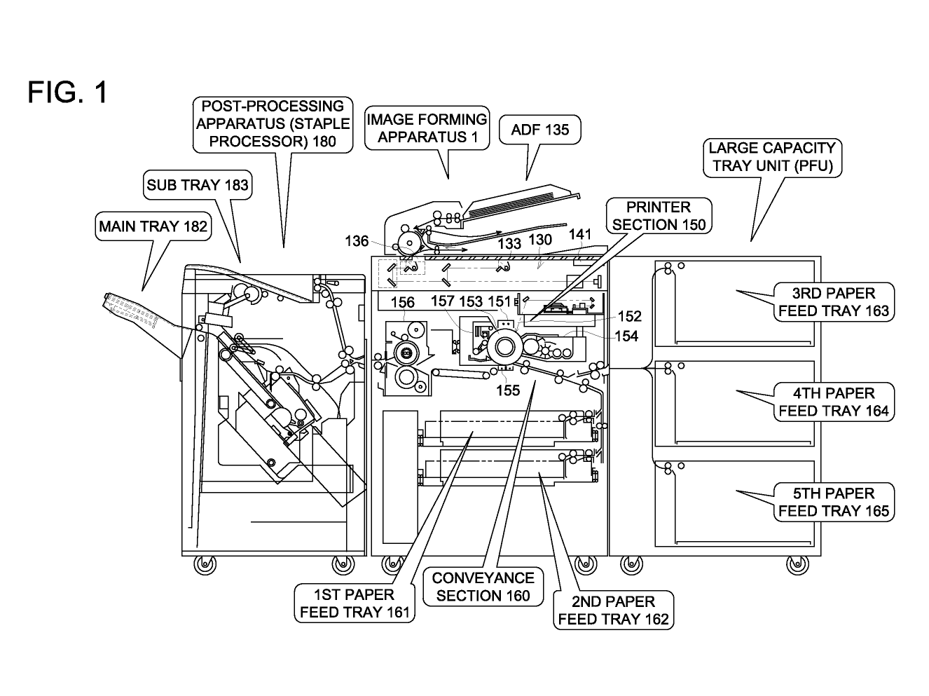

Henceforth, an embodiment of the present invention will be described based on the attached figures. FIG. 1 illustrates a mechanical configuration of an image forming apparatus of this embodiment of the present invention and will be described henceforth. An image forming apparatus 1 is a digital multi function peripheral that has a printer function, a scanner function and a copier function. In the upper side of the image forming apparatus 1, there are a scanner section 130, a platen glass 133 onto which a document will be placed, a slide feeding type automatic document feeding apparatus (ADF135) and an ADF document reading slit glass 136 that reads the document transmitted from ADF135. In the vicinity of the image forming apparatus 1, an operation section 140, which is capable of displaying information of the image forming apparatus 1 is provided. The operation section 140 is configured by a touch-sensitive LCD 141, which is capable of displaying information of and inputting information for the image forming apparatus 1.

A printer section 150 provided in the image forming apparatus 1 is equivalent to an image forming section. The printer section 150 is configured by a charging section 151, a LD section 152, a photoreceptor 153, a developing section 154, a transfer section 155, a fixing device 156 and a cleaning section 157.

The printer section 150 performs a uniform charging with the charging section 151 and writes in a latent image with the laser beam of the LD152 on the surface of the photoreceptor 153. An image is acquired by reading a document fed from ADF 135 of the scanner section 130, or by reading a document placed on the platen glass 133. The above-mentioned latent image is formed by performing a scan and exposure based on the image data. A reversal development of this latent image is performed by the developing section 154. Then a toner image is formed onto the surface of the photoreceptor 153.

A paper sheet fed from a first paper feed tray 161, a second paper feed tray 162, a third paper feed tray 163, a fourth paper feed tray 164 and a fifth paper feed tray 165 is transmitted to a transfer position by a conveyance section 160. Then, at the transfer position, the toner image on the photoreceptor 153 is transferred onto the paper by the transfer section 155. An image may be transferred onto the paper from the photoreceptor 153 via a secondary transfer section. Then, the paper onto which an image formation was performed is conveyed to downstream side by the conveyance section 160, and the image is heated and fixed onto the paper by the fixing device 156. Then the paper is conveyed to a post-processing apparatus (staple processor) 180. The photoreceptor 153 prepares for the next image formation by removing a development agent remaining on the surface of the photoreceptor 153 with the cleaning section 157 after the transfer.

In the lower section of the image forming apparatus 1, there is a plurality of tiers of the first paper feed tray 161 and the second paper feed tray 162, which store a recording medium and feed paper. Also on a side of the image forming apparatus 1, a large capacity tray unit (PFU) is provided. The third paper feed tray 163, the fourth paper feed tray 164 and the fifth paper feed tray 165 are provided in the large capacity paper feed tray unit. The paper of each paper feed tray is conveyed to the transfer position by the conveyance section 160 that is configured by a conveyance roller and a registration roller.

A recording medium onto which the image formation was performed is conveyed to the post-processing apparatus 180. The post-processing apparatus 180 functions as a staple processor. Therefore, the post-processing apparatus 180 bundles a plurality of papers transmitted from the image forming apparatus 1 and binds them with a staple. The post-processing apparatus 180 is configured by a main tray 182 and a sub tray 183. The paper to which the post-process was performed is ejected to the main tray 182. The paper to which the post-process was not performed is ejected to the sub tray 183.

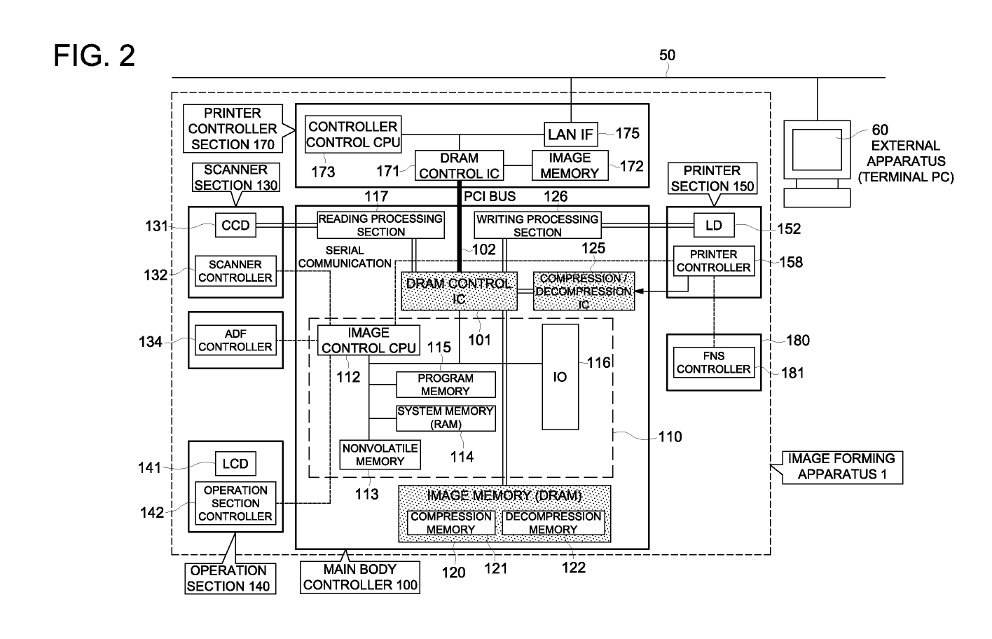

Next, FIG. 2 will be described henceforth. FIG. 2 illustrates a block diagram of the electric configuration of the image forming apparatus 1 in the embodiment. The image forming apparatus 1 is mainly configured by a main body controller 100, a scanner section 130, an operation section 140, a printer section 150 and a printer controller section 170 that processes the image data outputted and inputted between external devices (for example, a terminal such as an external apparatus 60) and the main body controller 100 via LAN 50.

The main body controller 100 is configured with a DRAM control IC 101 onto which a PCI bus 102 is connected. The main body controller 100 is configured with an image control CPU 112. The above-mentioned DRAM control IC 101 is connected to this image control CPU 112. A nonvolatile memory 113, a system memory (RAM) 114, a program memory 115 and an IO section 116 are also connected to the image control CPU 112. The nonvolatile memory 113 stores a program for operating the above-mentioned image control CPU 112 or setting data of the image forming apparatus 1. The nonvolatile memory 113 also stores management information of job and setting data of image forming apparatus 1, a process control parameter, paper setting of paper feed tray (paper size, paper type) and a priority order of paper feed trays. The system memory (RAM) 114 operates as a work area when the image control CPU 112 operates. A program for operating the image control CPU 112 is stored in the program memory 115. The IO section 116 operates as an interface for receiving and transmitting information between each section within the image forming apparatus 1. For example, in case when the IO section 116 receives a detection result of a sensor, which detects whether a paper sheet is in each paper feed tray or not, the IO section 116 transmits the detection result to the image control CPU 112.

The image control CPU 112 controls the entire image forming apparatus 1. The image control CPU 112 also performs start/stop/operation management of a job for a plurality of jobs. That is, the image control CPU 112 functions as a controller of the present invention with the nonvolatile memory 113, the system memory (RAM) 114, the program memory 115 and the IO section 116.

The above-mentioned scanner section 130 is configured by a CCD 131 and a scanner controller 132. The CCD 131 performs an optical reading. The scanner controller 132 performs control of the entire scanner section 130. The scanner controller 132 and the above-mentioned image control CPU 112 are connected so that they are able to perform serial communication. The scanner controller 132 receives control from the image control CPU 112. The scanner controller 132 can be configured by a CPU or a program to operate the CPU. A reading processing section 117 in the main body controller 100 performs data processing to the image data read in by the above-mentioned CCD 131. The reading processing section 117 is connected to the above-mentioned DRAM control IC 101.

The above-mentioned operation section 140 is configured by a touch-sensitive LCD 141 and an operation section controller 142. The above-mentioned LCD 141 and the operation section controller 142 are connected in the operation section 140. Then, the operation section controller 142 and the above-mentioned image control CPU 112 are connected so that they are able to perform serial communication. The operation section controller 142 can be configured by CPU or a program that operates the CPU. The operation control requirement of the image forming apparatus 1, such as various setup or operational command, can be inputted from the operation section 140. Further, a setting content, an apparatus state and information can be displayed at the operation section 140. The operation section 140 is controlled by the above-mentioned image control CPU 112.

The DRAM control IC 101 is connected to an image memory 120, which is configured by a compression memory 121 and a decompression memory 122. The image data acquired from the above-mentioned scanner section 130 and the image data acquired through LAN 50 are stored in this image memory 120. As mentioned above, the image memory 120 is a storage area of image data, and stores the image data of a job to be printed. The above-mentioned DRAM control IC 101 is capable of memorizing the image data of a plurality of jobs into the image memory 120.

Further, a compression/decompression IC 125 that decompresses or compresses image data is connected to the DRAM control IC 101. A writing processing section 126 is connected to the DRAM control IC 101. Further, the writing processing section 126 is connected to the LD 152 of the printer section 150. The write-in process section 126 processes the data used for operating this LD 152. The printer section 150 is provided with a printer controller 158 for controlling the entire printer section 150 The printer controller 158 and the above-mentioned image control CPU 112 are connected so that they are able to perform serial communication. Further, the printer controller 158 is controlled by the image control CPU 112. That is, a start/stop of print operation is performed according to the parameter given from the image control IC 112. The printer section 150 includes the above-mentioned conveyance section 160 and the first to the fifth paper feed trays 161-165. A command from the image control IC 112 controls a paper feed from a selected paper feed tray and controls paper conveyance of the conveyance section 160. Further, the post-processing controller 181 of the post-processing apparatus 180 is connected to the printer controller 158. Thereby, the image control CPU 112 controls the control of the post-processing apparatus 180 through the printer controller 158 and the post-processing controller 181. The printer controller 158 and the post-processing controller 181 can be configured by CPU or a program that operates the CPU.

A DRAM control IC 171 of the above mentioned printer controller section 170 is connected to the above-mentioned PCI bus 102 that is connected to the above-mentioned DRAM control IC 101. An image memory 172 is connected to the DRAM control IC 171 in the printer controller section 170. In the printer controller section 170, a controller control CPU 173 is connected to the above-mentioned DRAM control IC 171, and a LAN interface 175 is also connected to the DRAM control IC 171. The LAN interface 175 is connected to the above-mentioned LAN 50. The external apparatus 60 is connected to LAN 50.

Next, a fundamental operation of the above-mentioned image forming apparatus 1 will be described. First, a procedure for accumulating image data in the image forming apparatus 1 will be described. First, in case when reading an image of a document and generating the image data in the scanner section 130, the image of the document is optically read from the document by the CCD 131 in the scanner section 130. In this case, the scanner controller 132, which receives a command from the image control CPU 112, performs an operational control of the CCD 131. The reading processing section 117 performs data process to the image read in by the CCD 131. Then, the image data is compressed by a predetermined method in the compression/decompression IC 125 via the DRAM control IC 101. Then, the image data is stored in the compression memory 121 via the DRAM control IC 101. The image data stored in the compression memory 121 can be managed as a job by the image control CPU 112.

In case when externally acquiring image data, for example, image data transmitted from the external apparatus 60 through LAN 50 is temporarily stored in the image memory 172 by the DRAM control IC 171 via the LAN interface 175. The image data in the image memory 172 is decompressed by a predetermined method in the compression/decompression IC 125 via the DRAM control IC 171, the PCI bus 102 and the DRAM control IC 101. Further, the image data will be compressed by a predetermined method in the compression/decompression IC 125 via the DRAM control IC 101. Then, the image data is stored in the compression memory 121 via the DRAM control IC 101. Then, the image data is managed by the image control CPU 112 just as mentioned above.

In case when the image forming apparatus 1 performs an image output, namely, when the image forming apparatus 1 is used as a copying machine or a printer, the image data stored in the compression memory 121 is transmitted to a decompression IC 125 via the DRAM control IC 101. Then, the image data is decompressed. The data is accordingly stored in a decompression memory 122. The decompressed data is transmitted to the writing processing section 126. Then the image is written onto the photoreceptor 151 in the LD 152. In the printer section 150, the printer controller 158 receives a command from the image control IC 112. Then the printer controller 158 performs control of each section. Then the paper is fed from a predetermined paper feed tray. Then, the paper is conveyed by the conveyance section 160. The image on the photoreceptor 151 is transferred onto the conveyed paper by a transfer section 155. Then the fixing device fixes the image onto the paper. The paper onto which the image formation was performed, is conveyed to the post-processing apparatus 180 through the conveyance section 160. In case when there is a specification of post-processing, the paper is ejected onto a paper ejection tray 182 after the above-mentioned post-processing is performed. In case when the post-processing is not needed, the paper is ejected to a paper ejection tray 183 without any post-processing. In case when there is a plurality of requested jobs, the image control CPU 112 controls so that the above-mentioned image output is performed in order that corresponds to a set order.

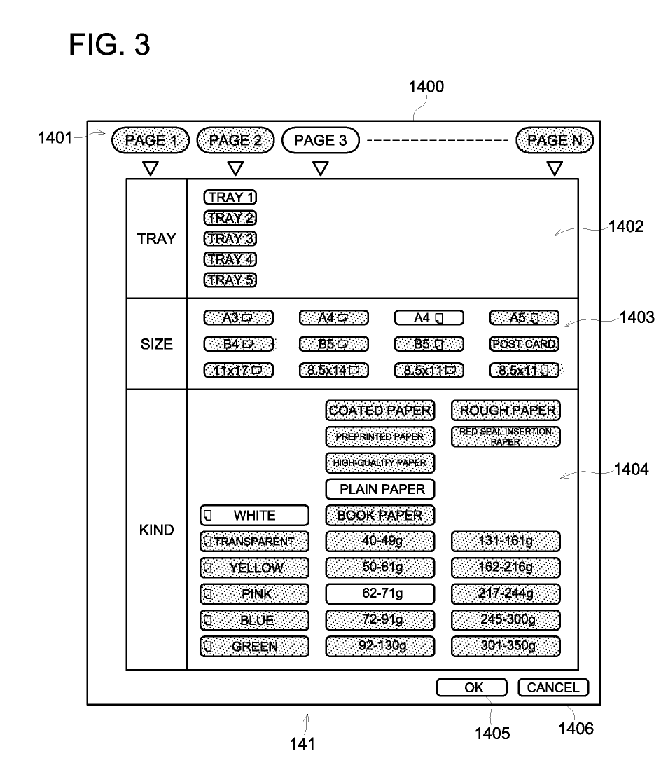

As mentioned above, the image control CPU 112 can perform management and execution of a job. In the image control CPU 112, when setting up a job, a paper size, a paper type and a paper teed tray can be separately set for every page. An operator can input the settings in the above-mentioned operation section 140. FIG. 3 illustrates a setting screen 1400 that indicates setting for every page and is displayed on LCD 141 in this operation section 140. This setting screen 1400 is displayed on the LCD 141 by the operation section controller 142, which receives a command from the image control CPU 112. An operator is able to input the setting with the setting screen 1400.

A page selection button 1401 is displayed for every page of a job on this setting screen 1400. Thus, by pressing the page selection button 1401 that corresponds to either page, the setting for the page can be performed. As a setting item, there are a tray number, a paper size and a paper type. In correspondence to each of the items, a plurality of selectable tray number buttons 1402, a plurality of selectable paper size buttons 1403 and a plurality of selectable paper type buttons are displayed. They are all selectable. In the paper type, a classification, a color and a basis weight of a paper sheet can individually be selected.

In each of the button group, the selected button will be highlighted. In case when another button is pressed after a selection, then, the content will be changed to the setting of the button that was pressed latter. In FIG. 3, “page 3” is a selection target. In the setting of “page 3”, “tray 1” is selected as the paper feed tray, A4 in a longitudinal (or portrait) direction is selected as the paper size, a color white, a regular paper and basis weight of “62-71g” are selected as the paper type. In case when another page is selected from the page selection button 1401 after the above mentioned page setting is performed, settings can be selected for other pages just as mentioned above. As an initial setting, a common setting is performed on each page. It may be arranged so that an operator can perform a setting for a desired page. All of the page settings can be confirmed by pressing an “OK” button 1405 of the setting screen 1400. Further, in case when a cancel button 1406 is pressed, all of the items in the setting are cancelled after the setting screen 1400 is displayed. Then the screen returns to a menu screen. The setting content of each page is stored in the image memory 120 along with the image data of the job. The setting content and the image data can be acquired by the image control CPU 112 via the DRAM control IC101.

In the controller 110, the paper size and the paper type (paper type, color and basis weight) of the paper stored in each paper feed tray can be set up from the above-mentioned LCD 141 (tray setup). The setting content is memorized by the nonvolatile memory 113 of the controller 110. In the image control CPU 112 reads out the paper size and the paper type for each of the above-mentioned paper feed tray memorized by the nonvolatile memory 113 when executing a job.

In the controller 110, when executing a job, a paper feed tray that performs paper feed is selected based on the setting content (a paper feed tray, paper size and paper type) pertaining to the image data while performing the image formation based on the image data stored in the image memory 120. In this selection, in case when there is no setting of a paper feed tray, an automatic paper selection (APS), which automatically selects a paper feed tray whose paper conditions (paper size and paper types) correspond to the setting content pertaining to the image data, is performed in the controller 110, a setting of priority order of paper feed trays is possible. The data of the priority order is stored in the above-mentioned nonvolatile memory 113. The image control CPU 112 reads out the priority order data as needed. For example, in the above-mentioned automatic paper selection, when selecting a paper feed tray that corresponds to the paper condition, in case when the priority order of the above-mentioned paper feed tray is set up, the paper feed tray on top of the priority order will automatically be selected according to the priority order.

Further, in the controller 110, in case when the paper runs out of a paper feed tray during a paper feed, it is possible to perform an automatic paper feed tray switching (ATS), which automatically selects a paper feed tray whose paper conditions corresponds to the paper condition of the setting content pertaining to the image data and continues the paper feed from a paper feed tray that will perform the paper feed after ATS is performed. At this time, in case when the above-mentioned priority order of paper feed trays was set, a paper feed tray on the top of the priority order will automatically be selected according to the priority order.

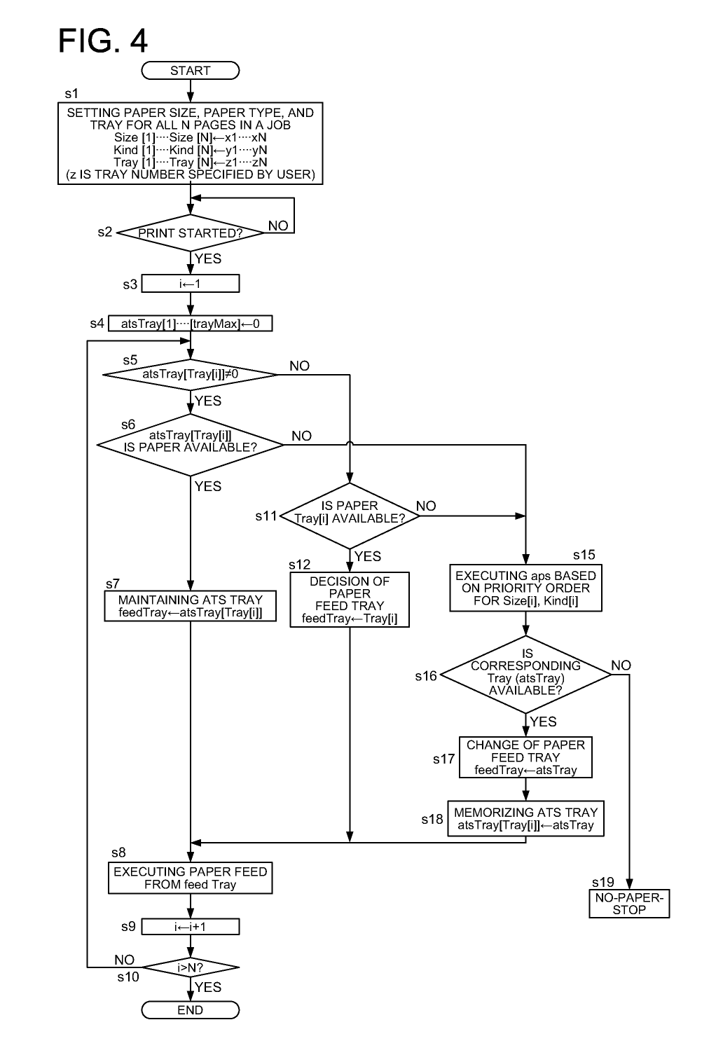

Next, in the present invention, a procedure of selecting a paper feed tray in case when a paper condition and the paper feed tray number for each page is set will be described based on the flow chart of FIG. 4. First, as illustrated in FIG. 4, a paper size (Size (xi)), a paper type (Type (yi)) and a paper feed tray number (Tray (zi)) are set up for every page of a job (i=1 . . . N (number of pages), STEP s1). Then, when an operator presses a start print button in LCD 141, the printing starts, that is, a job is executed (STEP s2, YES). Along with the start of the job, a determination to select a paper feed tray is sequentially performed from a first page (STEP s3). At this time, in case when ATS is performed to k-th (k=1 . . . trayMax (paper feed tray number)) paper feed tray, the number of the paper feed tray that was newly switched from the k-th paper feed tray will be managed by the controller 110 as an atsTray [k]. The data to be managed by the controller 110 can be stored in the nonvolatile memory 113 or the system memory (RAM) 114. In case when maintaining the data after the power source of an apparatus is turned off, the data to be managed is stored in the nonvolatile memory 113. “atsTray[k]=0” implies that ATS has not been executed to the k-th paper feed tray. Since ATS has not been executed, “0” will be substituted to all pages as an initial value (STEP s4). For i-th page, a tray number “Tray[i]”, which was set up at the time of generating a job, will be put into a place of “k”.

In determining and selecting a paper feed tray for every page, whether ATS has been executed to a paper feed tray for the page or not is verified using the value of atsTray [Tray[i]] (STEP s5). In case when the value is 0 and ATS has not been executed, whether there is a paper sheet in the paper feed tray (Tray [i]) set at the time of generating the job or not is determined (STEP s11). In case when there is paper in the paper feed tray (STEP s11, YES), a paper feed tray Tray[i] will be determined and set up to be used as a paper feed tray (feedTray) (STEP s12). The printing of the page is executed by performing a paper feed from this feedTray (STEP S8). Then, the process proceeds to the next page (STEP s9). After having confirmed that the process has not reached to the last page (STEP s10), the process proceeds to the above-mentioned STEP s5. In case when the last page is printed (STEP s10, YES), the process ends.

In case when the process has proceeded to an i-th page without performing ATS and there is no paper in a paper feed tray when performing a paper feed from the paper feed tray set up at the time of generating a job (STEP s11, NO), the paper feed tray that matches the condition based on the paper size and paper type of i-th page is automatically selected (APS, STEP s15). For example, APS can search for the paper feed tray that matches the conditions in the order of the paper feed tray number. Subsequently, whether there is a paper sheet in the paper feed tray that will be performing the paper feed after ATS is executed or not is determined by the controller 110 (STEP s16). In case when there is a paper sheet in the paper feed tray (STEP s16, YES), the paper feed tray (atsTray) that will be performing the paper feed after ATS is executed is assigned as a tray (feedTray) that actually performs the paper feed (STEP s17). In case when there is no paper in the paper feed tray, the apparatus stops (STEP s19). After assigning the paper feed tray (atsTray) as feedTray (STEP s17), the information of atstray [Tray[i]] of the paper feed tray which has been selected to perform the paper feedafter ATS is executed that indicates to which paper feed tray that the paper feed tray set for the i-th page was switched is memorized to the nonvolatile memory 113 or the system memory (RAM) 114 (STEP s18). Then, the paper feed is performed from the feedTray (STEP s8), and the above-mentioned procedure is repeated.

In case when ATS has been executed to the paper feed tray of i-th page in the above-mentioned procedure (STEP s5, YES), whether there is a paper sheet in the paper feed tray atsTray [Tray[i]] that will be performing the paper feed after ATS is executed is determined (STEP s6). In case when there is no paper in the paper feed tray (STEP s6, NO), APS is executed based on the paper size and the paper type of i-th page (STEP s15). Then, the same procedure as the above will be repeated henceforth. On the other hand, in case when there is paper in the paper feed tray that will be performing the paper feed after ATS is executed (STEP s6, YES), the paper feed tray (atsTray [Tray[i]]) that will be performing the paper feed after ATS is executed is maintained as feedTray (STEP s7). Then, the paper feed is performed from the paper feed tray (STEP s8), and the above-mentioned procedure is repeated.

The image forming apparatus is configured so that the job will be performed by continuously using the paper feed tray that has been performing the paper feed after ATS was executed in case when the paper runs out of the paper feed tray set for each page and even after a paper sheet is refilled into the paper feed tray that was performing the paper feed before ATS was executed. The paper feed tray that is performing the paper feed after ATS was executed will be maintained to perform the paper feed, and the paper feed tray that was performing the paper feed before ATS was executed is kept away from performing the paper feed at least until the job is completed. In case when the paper in the paper feed tray that is performing the paper feed after ATS was performed runs out, ATS will be executed again. However, the paper feed tray that was performing the paper feed before the first ATS was executed will not return unconditionally to perform the paper feed. In this case, the image forming apparatus may be configured so that ATS will be executed for the other trays excluding the paper feed tray that was performing the paper feed before the first ATS was executed. However, in this embodiment of the present invention, the image forming apparatus may be configured so that in case when the paper of the paper feed tray that is performing the paper feed after the ATS was executed runs out, the paper feed tray that was performing the paper feed tray before ATS was executed may be returned to perform the paper feed. The paper feed tray that was performing the paper feed after ATS was executed may continuously be used in a subsequent job. The image forming apparatus may be configured so that the continuous use of the paper feed tray that was performing the paper feed after ATS was performed may be cancelled as the power source of the apparatus is turned off. Thereby, in case when the power source of the apparatus is turned on again, the setting content for every page returns.

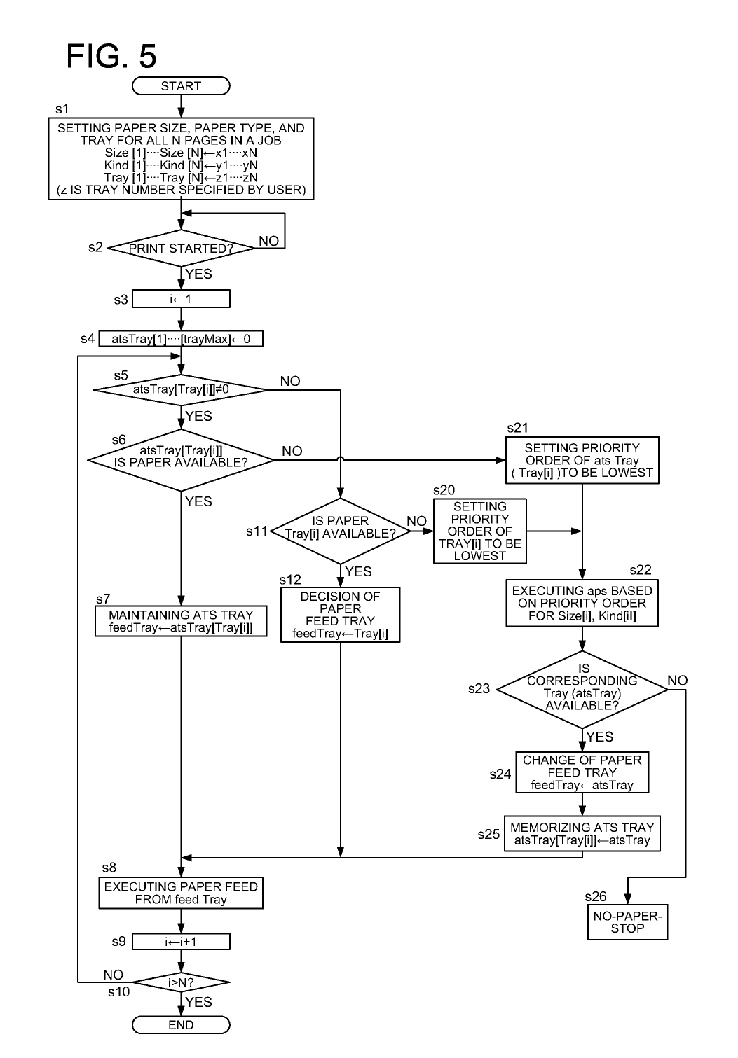

Next, a case where a priority order of the paper feed tray is set up in executing ATS will be described based on the flow chart of FIG. 5. The same step number will be attached to the steps that are the same as the above-mentioned procedure. Therefore, the description of those steps will be simplified or omitted. As in the above-mentioned procedure, a paper size (Size(xi)), a paper type (Type (yi)) and a paper feed tray number (Tray (zi)) are set for every page of a job (STEP s1). Then, a printing (job) is started (STEP s2, YES). Along with the start of the job, determination and selection of a paper feed tray is sequentially performed from a first page (STEP s3). In determining and selecting a paper feed tray for every page, in case when ATS has not been executed to the paper feed tray for the page (STEP s5, NO), whether there is paper in the set paper feed tray or not is determined (STEP s11). In case when there is a paper sheet in the paper feed tray (STEP s11, YES), the paper feed tray Tray[i] will be set and defined as a paper feed tray (feedTray) to perform the paper feed (STEP s12). The printing of the page is executed by performing paper feed from the paper feed tray (STEP s8). Then, the process proceeds to the next page (STEP s9). After verifying whether or not the last page was printed (STEP s10), the process returns to the above-mentioned STEP s5.

In case when there is no paper in the paper feed tray when performing the paper feed from the set paper feed tray without executing ATS in i-th page (STEP s11, NO), the tray with no paper will be put in the lowest of the priority order. The priority order that was changed is memorized by the nonvolatile memory 113 in the controller 110 (STEP s20). Then, based on the paper size and the paper type of i-th page, the paper feed tray that matches with the condition of i-th page will be automatically selected from the priority order of the paper feed tray (APS, STEP s22). Subsequently, whether there is paper in the paper feed tray that will be performing paper feed after ATS is executed is determined (STEP s23). In case when there is a paper sheet in the paper feed tray (STEP s23, YES), the paper feed tray (atsTray) that will be performing the paper feed after ATS is executed is assigned to a tray (feedTray), which feeds paper (STEP s24). In case when there is no paper in the paper feed tray, the apparatus stops (STEP s26). After assigning the paper feed tray (atsTray) as feedTray (STEP s24), the information atsTray [Tray[i]] of the paper feed tray that will be performing the paper feed after ATS is executed that indicates to which paper feed tray the paper feed tray set for the i-th page was switched is memorized to the nonvolatile memory 113 or the system memory (RAM) 114 (STEP s25). Then, the paper feed is executed from the feedTray (STEP s8), and the above-mentioned procedure is repeated.

In case when ATS was executed on the paper feed tray of i-th page in the above-mentioned procedure (STEP s5, YES), whether there is a paper sheet in the paper feed tray atsTray [Tray[i]] that will be performing the paper feed after ATS is executed is determined (STEP s6). In case when there is no paper in the paper feed tray (STEP s6, NO), the paper feed tray with no paper will be changed to the lowest of the priority order. The priority order that was changed will be memorized to the nonvolatile memory 113 (STEP s21). After the priority order was changed, APS is executed as mentioned above (STEP s22). The same procedure as mentioned above will be repeated henceforth. On the other hand, in case when there is paper in the paper feed tray that will be performing the paper feed after ATS was executed (STEP s6, YES), the paper feed tray that performs paper feed after ATS was performed will be maintained as feedTray (STEP s7). Then, the paper feed is performed from the paper feed tray (STEP s8). Then, the above-mentioned procedure is repeated. In case when paper runs out of the paper feed tray set for every page and ATS is executed in the above-mentioned procedure, since the paper feed tray is put on the lowest of the priority order even in case when paper was refilled into the paper feed tray that was performing paper feed before ATS was executed, the paper feed tray will not be preferentially selected in executing ATS. Therefore, a plurality of paper feed trays can be evenly used.

In the above, the present invention has been described based on the above-mentioned embodiment. However, the present invention is not limited to the description of the above-mentioned embodiment, and can be changed in the range, which does not depart from the scope of the present invention.

According to the image forming apparatus of the present invention, the image forming apparatus includes a plurality of paper feed trays and a controller, which executes a job, performs a job management, and has an automatic tray switching function that continues to perform paper feed by automatically switching to the other paper feed tray in which a paper sheet that matches the paper condition in case when a paper sheet in a paper feed tray runs out while performing paper feed while executing a job. The controller is capable of setting a paper size/ a paper type/ a tray to be used for every page of a job. After paper in a paper feed tray performing paper feed runs out and the paper feed tray is switched to another tray by the automatic tray switching function while executing the job, in case when paper is refilled into the paper feed tray from which paper ran out, even in case when the paper feed tray into which paper was refilled was set as a paper feed tray for every page, the paper feed tray that was switched to by the automatic tray switching function will be continuously used without using the paper feed tray into which paper was refilled. Therefore, rapid deterioration of expendable supplies of tray and deterioration of paper can be prevented by uniformly using a plurality of trays without concentrically using a specific paper feed tray. Since the paper feed tray that was used before ATS was performed will not be switched back to perform paper feed even in case when paper was refilled, there is no need for suspension of refilling paper to avoid switching of the paper feed tray. Therefore, paper can be refilled at a desired time. Even in case when paper put in order, such as a tab paper and previously printed paper, is set in a plurality of trays, and in case when paper was refilled into the paper feed tray that was performing paper feed before it was switched by the ATS function, the paper feed tray that performs paper feed after ATS was performed will continuously be used. Therefore, the paper stored in order can be fed and used as planned.

What is claimed is:

1. An image forming apparatus comprising:
a printer section to form an image on a paper sheet;
a plurality of paper feed trays to feed the paper sheet; and
a controller which controls the image forming apparatus to execute a job, and the controller having a function of executing an automatic tray switching where in cases where a paper feed tray runs out of a paper sheet while performing the paper feeding for executing the job, the controller continues the paper feeding by automatically switching to another paper feed tray containing a paper sheet that matches paper conditions for the job,
wherein, the controller is capable of setting a paper size, a paper type, and a paper feed tray to be used for each page of the job, and
wherein in cases where a first paper feed tray is refilled with the paper sheet, after the first paper feed tray performing paper feeding runs out of the paper sheet in the course of executing a first job and the first paper feed tray is switched to a second paper feed tray by the automatic tray switching function, the controller continues to feed the paper sheet by using the second paper feed tray without using the first paper feed tray which is refilled with the paper sheet, even in cases where the first paper feed tray has been set as a paper feed tray for the each page of the first job.

2. The image forming apparatus of claim 1, wherein the controller uses the second paper feed tray as the paper feed tray being set for the each page of the job, without using the first paper feed tray, at least during a period when the first job is executed.

3. The image forming apparatus of claim 1, wherein the controller uses the second paper feed tray as the paper feed tray being set for each page of jobs subsequent to the first job without using the first paper feed tray.

4. The image forming apparatus of claim 1, wherein the controller uses the second paper feed tray as the paper feed tray being set for each page of jobs without using the first paper feed tray, until the second paper feed tray runs out of the paper sheet.

5. The image forming apparatus of claim 4, wherein after the second paper feed tray runs out of the paper sheet, the controller uses the first paper feed tray which has been refilled with the paper sheet after the automatic tray switching, as the paper feed tray being set for each page of the jobs.

6. The image forming apparatus of claim 1, wherein the controller uses the second paper feed tray as the paper feed tray being set for each page of jobs without using the first paper feed tray, until a power switch of the image forming apparatus is turned off.

7. The image forming apparatus of claim 1, wherein the controller uses the first paper feed tray, which has been refilled with the paper sheet after the automatic tray switching, as the paper feed tray being set for each page of jobs subsequent to the first job.

8. The image forming apparatus of claim 1, wherein in cases where the second paper feed tray runs out of the paper sheet, the controller executes the automatic tray switching with respect to the plurality of paper feed trays excluding the first paper feed tray.

9. The image forming apparatus of claim 1, wherein in cases where the second paper feed tray runs out of the paper sheet, if the automatic tray switching is incapable with respect to the plurality of paper feed trays excluding the first paper feed tray, the controller uses the first paper feed tray which has been refilled with the paper sheet after the automatic tray switching, as the paper feed tray being set for each page of the jobs.

10. The image forming apparatus of claim 1, wherein the controller is capable of setting a priority order of the plurality of paper feed trays, and in cases of executing the automatic tray switching, the controller switches to another paper feed tray in accordance with the priority order of the plurality of paper feed trays.

11. The image forming apparatus of claim 10, wherein in cases of executing the automatic tray switching, the controller switches to the another paper feed tray, based on the paper conditions set for each page of the job, and in accordance with the priority order of the plurality of paper feed trays.

12. The image forming apparatus of claim 10, wherein in cases where a paper feed tray runs out of the paper sheet, the controller changes the priority order such that an order of the paper feed tray, which runs out of the paper sheet, comes to be a lower order.

13. The image forming apparatus of claim 12, wherein in cases where a paper feed tray runs out of the paper sheet in the course of executing the job, the controller changes the priority order such that an order of the paper feed tray, which runs out of the paper sheet, comes to be the lowest order.

14. The image forming apparatus of claim 12, wherein the controller keeps the priority order, changed when the paper feed tray ran out of the paper sheet in the course of executing the job, even after the job being finished.

15. The image forming apparatus of claim 12, wherein the controller keeps the priority order, changed when the paper feed tray ran out of the paper sheet, until the another paper feed tray comes out of the paper sheet.

16. The image forming apparatus of claim 1, wherein paper conditions include conditions of a paper size, a paper type, and a paper feed tray to be used.

17. The image forming apparatus of claim 1, wherein the job to be executed is image formation on paper sheets that are loaded in a paper feed tray in a predetermined order.

18. The image forming apparatus of claim 17, wherein the paper sheets are tub paper sheets or previously printed paper sheets.
